(19) United States
(12) Patent Application Publication
(10) Pub. No.: US 2021/0136471 A1
(43) Pub. Date: May 6, 2021

(54) AUDIO DEVICE

(71) Applicant: MICROSOFT TECHNOLOGY LICENSING, LLC, Redmond, WA (US)

(72) Inventors: Tommi Antero RAUSSI, Tampere (FI); Sailaja MALLADI, Kirkland, WA (US); Ross Garrett CUTLER, Clyde Hill, WA (US)

(73) Assignee: MICROSOFT TECHNOLOGY LICENSING, LLC, Redmond, WA (US)

(21) Appl. No.: 16/672,368

(22) Filed: Nov. 1, 2019

(51) Int. Cl. H04R 1/02; H04R 1/40; H04R 3/00; H04R 1/04

(52) U.S. Cl. CPC H04R 1/025; H04R 1/406; H04R 2201/029; H04R 1/04; H04R 3/005

(57) ABSTRACT

An audio system including an audio device secured within a receptacle for improving voice communication is disclosed. The audio device includes a housing containing a down-firing speaker that is positioned directly above an acoustic reflector formed by surfaces associated with the bottom of the housing and a corresponding interior of the receptacle. An apex protrudes upward from the center of the receptacle toward the diaphragm of the speaker. The acoustic reflector is characterized by a curved volume extending from the apex to an outer peripheral border of the receptacle. The structural features of the audio device and receptacle are configured to significantly improve the quality of sound produced by the audio system such that it fulfills standardized wideband audio performance requirements in a compact package.

### BACKGROUND

Many technologies are currently available for use during meetings and tele-conferencing sessions, including microphone arrays and loudspeakers. However, balancing the need to present clear, high-quality audio rendering and voice capture in rooms with large numbers of participants with the desire for a compact, lightweight audio system has been challenging. Traditionally, in order to provide a microphone array and speaker communication apparatus suitable for use, for example, when a plurality of participants in a large conference room are holding a conference with remote participants, multiple audio device stations have been utilized that can be linked together. It is therefore desirable to provide a more compact communication system with an emphasis on audio quality and portability.

### SUMMARY

A receptacle for an audio device, in accordance with a first aspect of this disclosure, includes a bottommost substrate base layer, a raised portion extending distally upward from a central region of the substrate base layer, the raised portion including an apex, and a base portion extending around the apex, and a recessed portion surrounding the base portion. The recessed portion extends from the base portion to a peripheral border portion of the substrate base layer, and includes a first sloped surface extending downward from the base portion to a nadir of the recessed portion and a second slope extending upward from the nadir to the peripheral border portion.

An audio system, in accordance with a second aspect of this disclosure, includes an audio device including a downwardly-oriented speaker, where the speaker includes a central vertical axis, as well as a receptacle configured to receive the audio device. The receptacle includes a substrate base layer, a raised portion extending from a base portion distally upward to an apex in a central region of the substrate base layer, the apex being approximately aligned with the central vertical axis, and a recessed portion of the substrate base layer encircling the raised portion. The recessed portion includes a continuously curved, concave surface extending in a radially outward direction from the base portion to a peripheral border portion that surrounds the recessed portion.

An audio system, in accordance with a third aspect of this disclosure, includes a receptacle and an audio device. The receptacle includes a substrate base layer that further includes a raised portion extending radially inward from a base portion to an apex, a recessed portion encircling the raised portion, and a peripheral border portion surrounding the recessed portion. The audio device is disposed within the receptacle and located directly above the substrate base layer. The audio device includes a housing assembly including a lower housing unit joined to an upper housing unit, the lower housing unit including an aperture and a downwardly-facing exterior surface that surrounds the aperture, and a speaker disposed in the housing assembly, the speaker including a diaphragm with an outermost ring configured to align with the aperture of the lower housing unit. The exterior surface of the lower housing unit is spaced apart from the recessed portion, and a distance between the exterior surface and the recessed portion increases in a radially outward direction.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

The drawing figures depict one or more implementations in accord with the present teachings, by way of example only, not by way of limitation. In the figures, like reference numerals refer to the same or similar elements. Furthermore, it should be understood that the drawings are not necessarily to scale.

FIG. 1 illustrates an example of an audio system that includes an implementation of a housing receptacle.

FIG. 2 is an exploded view of an implementation of the audio system.

FIG. 3 is an isometric exploded view of an implementation of a portion of the audio system.

FIG. 4 is a first isometric cutaway view of an implementation of the audio system along a midline.

FIG. 5 is a second isometric cutaway view of an implementation of the audio system along a midline.

FIGS. 6A and 6B are cutaway views of an implementation of the audio system along a midline.

FIG. 7 is an isolated isometric view of an implementation of the housing receptacle.

FIG. 8 is a cutaway view of an implementation of the housing receptacle along a midline.

FIG. 9 is an isometric view of the audio system with an external covering.

FIG. 10 is an implementation of the audio system with a microphone array.

### DETAILED DESCRIPTION

In the following detailed description, numerous specific details are set forth by way of examples in order to provide a thorough understanding of the relevant teachings. However, it should be apparent that the present teachings may be practiced without such details. In other instances, well known methods, procedures, components, and/or circuitry have been described at a relatively high-level, without detail, in order to avoid unnecessarily obscuring aspects of the present teachings. In the following material, indications of direction, such as “top” or “left,” are merely to provide a frame of reference during the following discussion, and are not intended to indicate a required, desired, or intended orientation of the described articles.

The following implementations introduce an audio system designed to foster inclusivity, productivity, and engagement in meetings and other sound-based interactions. The proposed system is a smart communication apparatus that includes a microphone array and a speaker that are arranged to offer a higher quality audio experience than traditional sound devices. The smart audio device includes a downward-facing speaker that is contained in a small, compact housing. This housing is positioned in a housing receptacle that serves to securely raise the housing from a substrate base layer (also referred to herein as “substrate”, “substrate layer”, and “base layer”) of the system. The particular size and dimensions and physical characteristics of the housing receptacle, in conjunction with the geometry of the housing, are configured to significantly improve the performance of the internal speaker in part by serving as an acoustic reflector and/or acoustic chamber. Such a system can serve as a sole audio endpoint in a room and, through access to and/or incorporation of virtual assistant and other cloud-based applications, provide real-time speech and transcription services, language translation, and/or automated note taking, in some examples with live diarization that can readily identify each person speaking during a meeting.

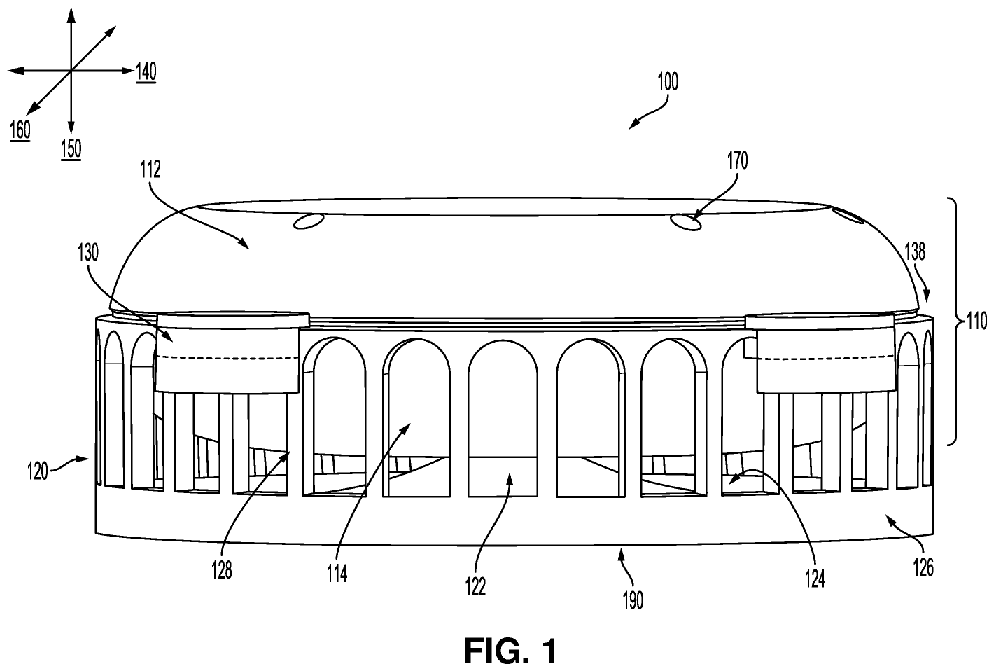

In order to better introduce the proposed systems to the reader, FIG. 1 presents an isometric view of an example of an audio system (“system”) 100, including a housing assembly (“housing”) 110 and a housing receptacle (“receptacle”) 120. The housing 110 includes a first housing unit (“first unit”) 112 joined, connected, attached, installed, coupled, and/or affixed to a second housing unit (“second unit”) 114. In this example, the second housing unit 114 is disposed below the first housing unit 112. Throughout this description, the first housing unit 112 may also be referred to as the upper housing unit and the second housing unit 114 may also be referred to as the lower housing unit.

The receptacle 120 includes a substrate 190 that has a substantially circular or round shape in a horizontal plane. The receptacle 120 can be observed to include several physical formations extending from various regions of the substrate 190, such as a protruding, raised portion 122 in a central region of the receptacle 120, a dipped, recessed portion 124 surrounding the raised portion 122 that extends radially outward to a peripheral border portion (“peripheral border”) 126 of the substrate 190. In addition, a plurality of elongated pillars 128 extend in an upward direction from the peripheral border 126 and surround the housing 110. The pillars 128 terminate at and are joined together by a receiving ring portion (“receiving ring”) 138 that is also substantially circular. In some implementations, the diameter of the receiving ring 138 above is approximately equal to the diameter of the substrate 190 below. The receiving ring 138 can be understood to provide an entryway or access opening to a partially open ‘chamber’ (defined by the arrangement of pillars 128), in which the housing 110 is partly submerged, supported, and secured.

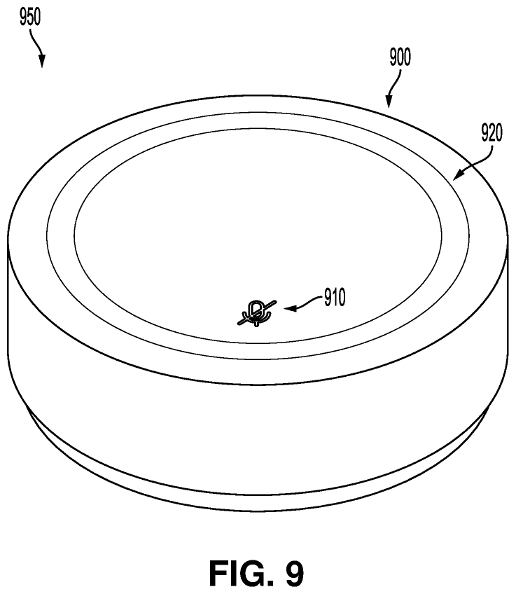

In some implementations, a set of connecting mechanisms 130 are also included for securing the housing 110 to the receptacle 120. Furthermore, as will be discussed in greater detail with reference to FIGS. 9A and 9B, in some implementations, the system 100 can include a microphone array that may be incorporated within a portion of an interior space of the housing 110, for example directly adjacent to or below a topmost surface 170.

Throughout this disclosure, reference is also made to directions or axes that are relative to an intended orientation of the system 100. For example, the term “distal” refers to a part that is located further from a center of the bottom surface of the substrate 190 of the receptacle 120 configured to contact or rest on a table or other location, while the term “proximal” refers to a part that is located closer to the center of the bottom surface of the receptacle 120. As used herein, the “center of the system” could be the centroid, the center of mass, a central plane, and/or a centrally located reference surface. Furthermore, for purposes of reference, a set of orthogonal axes is also identified in the drawings, including a horizontal axis 140, a vertical axis 150, and a lateral axis 160.

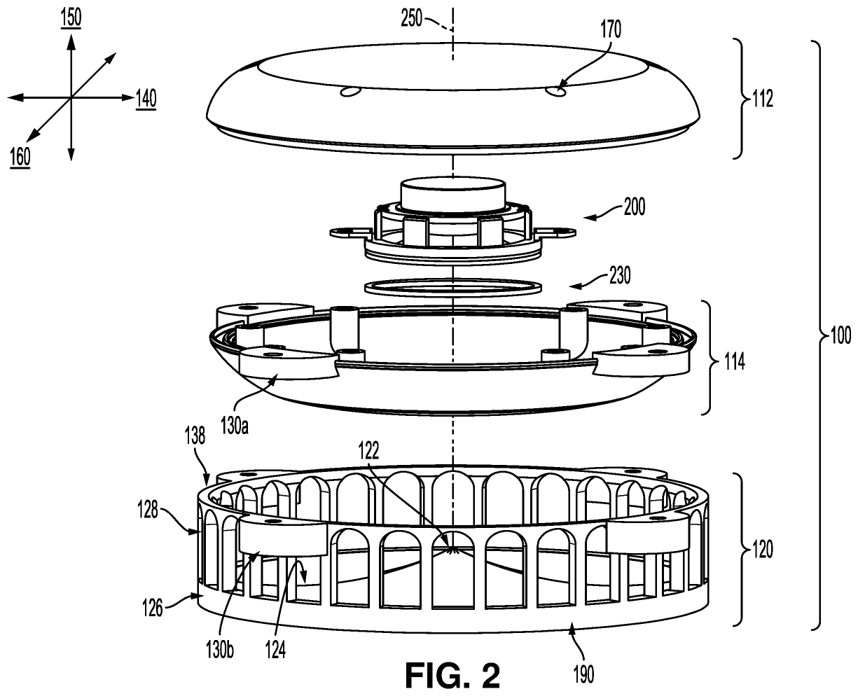

In order to provide a greater understanding of the components of the system 100, FIG. 2 presents an exploded view of the system 100. In different implementations, the system 100 may include a variety of components not necessarily illustrated here, including one or more of a logic machine (for example, one or more processors), an information storage machine (for example, one or more memory devices), an energy storage subsystem (for example, one or more batteries), a communications subsystem (for example, one or more wireless and/or wired communication devices to communicate with other electronic devices), an input/output subsystem (for example, one or more user input and/or output devices), and/or other components. As one example, the system 100 includes a speaker 200 that forms part of an output subsystem.

As noted in FIG. 1, the housing assembly 110 includes two housing units 112 and 114. In FIG. 2, the first unit 112 and the second unit 114 have been separated, revealing an interior chamber in which the speaker 200 is disposed. Collectively, the first unit 112, second unit 114, and speaker 200 will also be referred to as an audio device. In some embodiments, the speaker 200 is aligned such that a magnet of the speaker 200 is disposed nearer to the first unit 112 than a concave diaphragm of the speaker 200, while the diaphragm is disposed nearer to the second unit 114 while the magnet is disposed further away from the second unit 114. In other words, the audio-emitting source of speaker 200 is oriented in a downward direction (i.e., as a down-firing speaker), facing toward the raised portion 122 of the receptacle 120. Throughout this description, the speaker 200 may also be referred to as a downward-facing or downwardly oriented speaker.

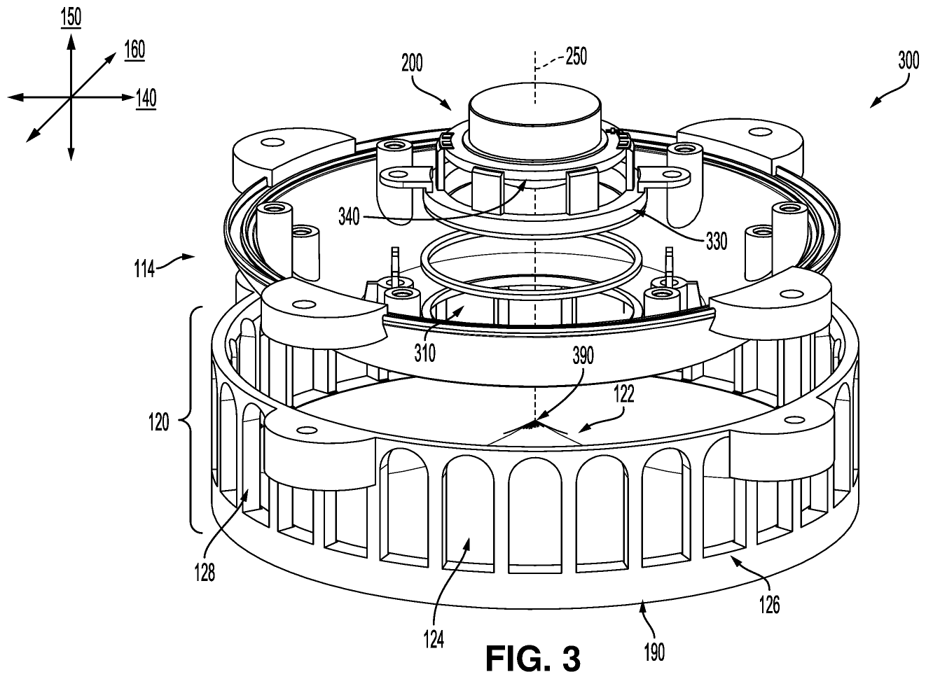

As shown in FIG. 2, the components of system 100 are arranged in a specific arrangement relative to one another. For example, the first unit 112 is positioned furthest or most distal from the substrate 190, and configured for attachment to the second unit 114, and the second unit 114 is disposed closer to the substrate 190 than the first unit 112. The speaker 200 is installed or positioned within the housing 110 directly adjacent to an interior surface of the second unit 114. Between the housing 110 and the speaker 200 may be an optional gasket 230 that is configured to provide or optimize a seal between the speaker 200 and the second unit 114 (see FIG. 3). Furthermore, in some implementations, the system 100 and/or components of system 100 may be symmetrical about a vertical plane aligned with a central vertical axis or midline 250.

As noted earlier, some or all components of the system 100 can include connecting mechanisms 130 that may each be sized and dimensioned to permit the housing 110 to be snugly and/or securely received and held in the receptacle 120. FIG. 1 illustrates example connecting mechanisms 130 including a first connecting portion (“first connector”) 130a, referring to a set of protruding portions extending from an outer periphery of the housing 110 (for example, an outer periphery of the second unit 114), that are each configured to be mated, connected, or attached (for example by an adhesive or other mechanical fastener) to each of a second connecting portion (“second connector”) 130b set included in the connecting mechanisms 130 and protruding from the exterior side of the receiving ring 138 of the receptacle 120 as well as along a portion of some of the pillars 128. Thus, the housing 110 may be oriented with the receptacle 120 in such a way so as to ‘line up’ the two sets of connecting portions 130a and 130b and facilitate an assembly process. In other implementations, the connectors 130a or 130b can instead refer to a male-female connector plug mechanism. It is noted that although FIGS. 1-7 show connecting mechanisms 130 that extend to protrude from a periphery of the housing 110 or the receptacle 120, in some implementations the connecting mechanisms 130 do not extend to protrude, so as to not increase a diameter of the system 100.

In different implementations, the housing 110 and the receptacle 120 may be physically and, in some cases, electrically connected to each other via insertion or placement of the housing 110 into an opening formed by the receptacle 120 and securing the system 100 by the joining of the first connector 130a to second connector 130b to form what will be referred to as a mated or assembled configuration. In the assembled configuration, the speaker 200 is configured to operatively interface or perform in conjunction with the structural features provided by receptacle 120. Furthermore, in an assembled configuration, the receptacle 120 provides structural and functional support to the housing 110, including, for example, elevating the speaker 200 from a surface on which the receptacle 120 is placed. Thus, in different implementations, the housing 110 and portions thereof (e.g., first unit 112 and second unit 114) and receptacle 120 may be physically separated, thereby disconnecting the two components and providing access to the interior of the housing 110 and interior regions of the receptacle 120 for purposes of, for example, diagnostics, repairs, or part replacement.

In some implementations, the first connector 130a and/or the second connector 130b may include one or more magnetically attractable elements that assist in bringing together the two connectors. For example, such magnetically attractable elements may include a permanent magnet, an electromagnet, or a material element that is attractable by a magnet (for example, a magnetically attractable metal-based material), or other such magnetic elements. In some implementations, the first unit 112 and/or second unit 114 of the housing 110 can include additional features to facilitate the mating of the first unit 112 to the second unit 114. For example, the first unit 112 includes an insertable wall extending downward from an outer circumference. The wall is slightly offset toward an interior of the first unit 112 and may be received by and/or secured within a groove formed in an outer circumference of the second unit 114.

FIG. 3 depicts an isometric view of a portion 300 of the system 100 in which the upper housing unit 112 has been omitted to better illustrate the relative arrangement of the system 100. In FIG. 3, the remaining components are tilted or angled forward, toward the viewer, such that an alignment and interconnection between the speaker 200 with an aperture 310 formed in the second unit 114 can be observed. The midline 250 extends through a center of the audio system 100, and so also passes through a center of the speaker 200, a center of the circular aperture 310, and an apex 390 of the raised portion 122. When assembled, an outermost ring 330 of the diaphragm of speaker 200 is configured to contact or be secured directly adjacent to the inner circumferential edge defining aperture 310. The gasket 230 can provide a soundproof seal between the speaker 200 and the housing 110. The positioning of the speaker 200 in or on the inner edge defining aperture 310 ensures that the speaker is oriented directly above and in close proximity to the raised portion 122 of the receptacle 120 when the housing 110 is inserted into the receptacle 120.

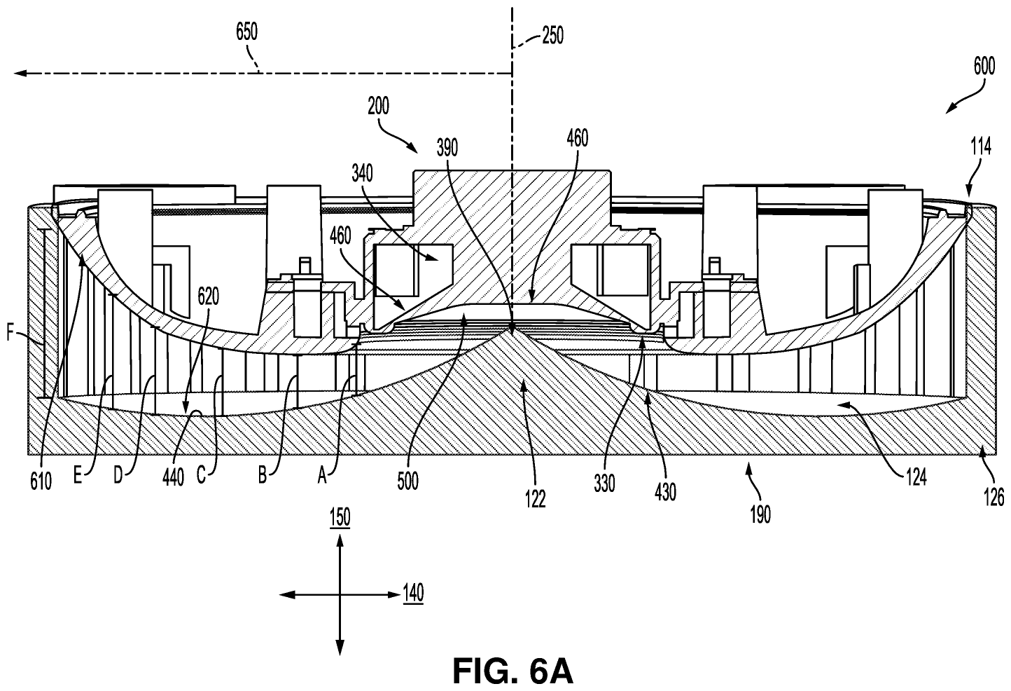

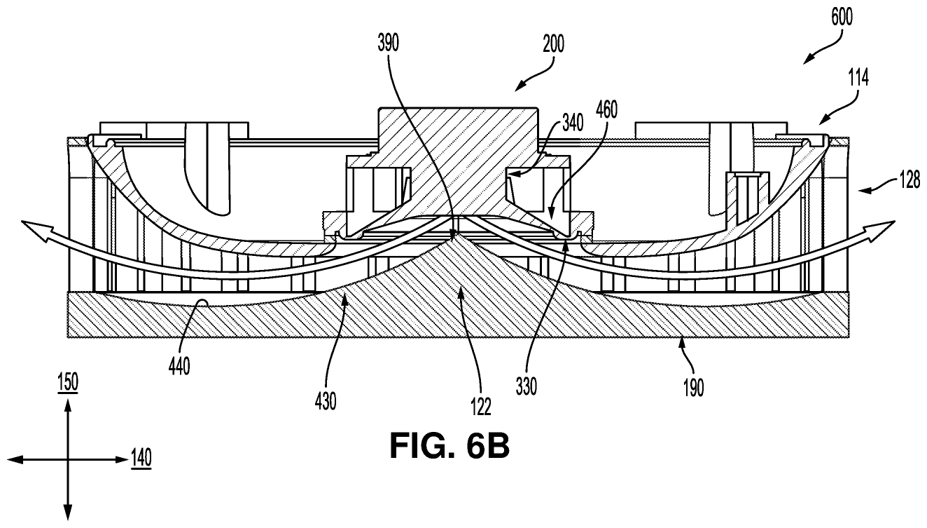

More specifically, in some implementations, the speaker 200 can be oriented such that a center or central axis of a speaker voice coil (also referred to herein as “speaker coil” or “voice coil”) 320 of the speaker 200 is directly above and substantially aligned with an apex 390 of the raised portion 122 (i.e., along the midline 250), where the apex 390 is located at an approximate center point of the receptacle 120. In some implementations, the apex 390 may be a vertex or include a pointed end, where the raised portion 122 gradually decreases or tapers in volume and circumference until reaching the highest point corresponding to the apex 390. Furthermore, the center or central region of the concave diaphragm is also substantially aligned with or about the apex 390. Thus, in some implementations, the audio-emitting source of the speaker is centered about the apex 390, allowing the structural characteristics associated with raised portion 122 and recessed portion 124 to carry sound emitted from speaker 200 in a consistent and uniform manner (see FIG. 6B).

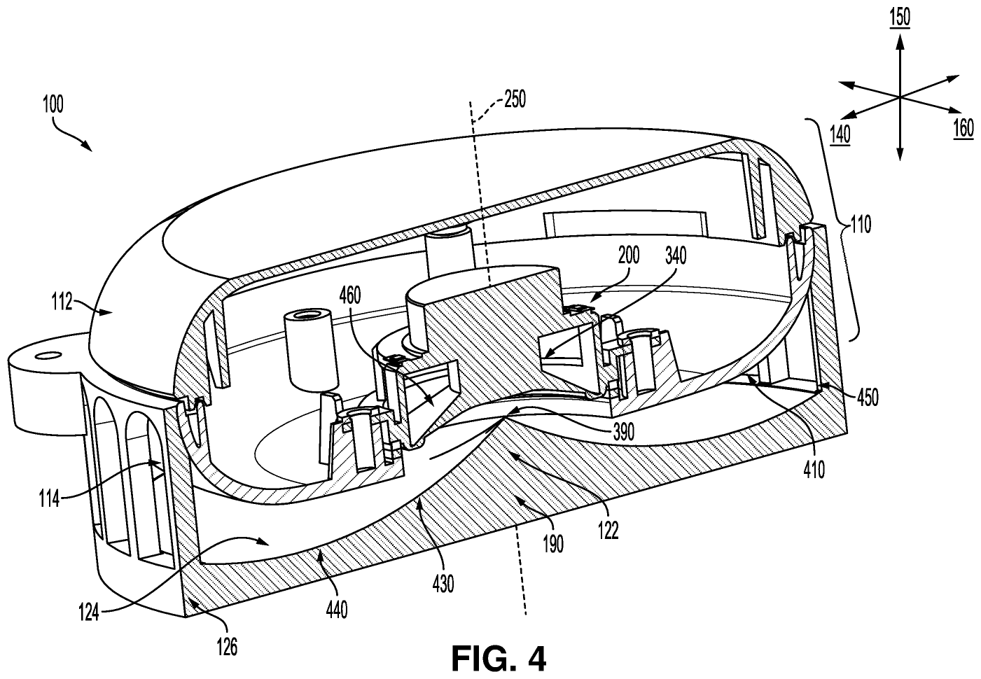

Referring now to FIGS. 4-6B, a sequence of cross-sectional cutaway views taken along a central vertical plane perpendicular to the lateral axis 160 are illustrated. FIG. 4 is an isometric view of an interior of the system 100 in which a cross-section of the internal structure of the system 100 is visible in an assembled configuration. A diaphragm 460 of the speaker 200 is arranged such that the larger open end of its concave structure is oriented toward the raised portion 124. Furthermore, the views of FIGS. 4-6B reveal the particular structural characteristics of the receptacle 120 in greater detail. For example, the curvature associated with the features formed on the substrate 190 can now be observed. The raised portion 122 is shown to extend upward from a base portion 430 to apex 390, forming a substantially pyramidal shape. The apex 390 can be seen to ‘point’ directly into a center of the diaphragm 460 as well as toward a center of the substantially cylindrical coil 340. Furthermore, the recessed portion 124 extends from just beyond the base portion 430, dips down to a nadir 440, and curves upward again to the peripheral border 126. Thus, the curvature of the recessed portion 124 may also be referred to as a concave surface. This outer (upwardly-facing) surface of recessed portion 124 can be understood to include a substantially continuous curve, moving first in a downward sloped surface from the nadir 390 and then in an upward sloped surface along a radially outward direction.

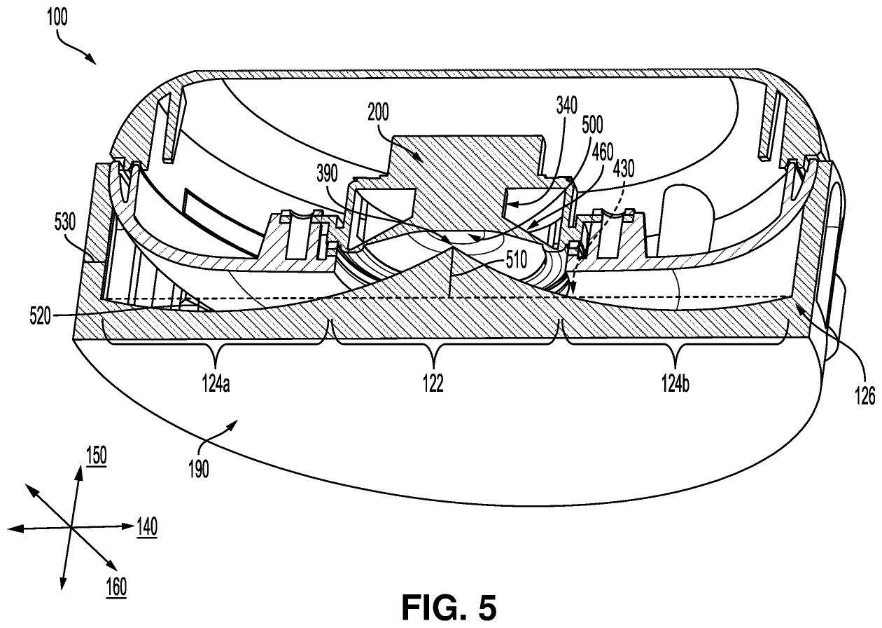

FIG. 5 presents the cross-sectional cutaway in a view that is tilted upward to further reveal an inner surface 500 of the diaphragm 460. In FIG. 5, the incursion of a portion of the raised portion 122 and in particular the apex 390 into a substantially hollow concave volume or cavity 500 that is defined by the inner surface 500 of the diaphragm 460 can be seen. In some implementations, the diaphragm 460 can include a substantially cylindrical pyramid shape. While the speaker 200 and the apex 390 are positioned closely, it should be understood that the two components do not actually make contact with one another, including speaker excursions occurring in operation.

FIG. 5 also more clearly illustrates the curvature of the interior surface of the receptacle 120. For purposes of reference, a dotted line has been added, extending from a first endpoint of the peripheral border 126 to a second, opposite endpoint of the peripheral border (e.g., corresponding to a diameter line). In this example, the dotted line is parallel to horizontal axis 140 and is further aligned to coincide or intersect with the base portion 430. In other words, the base portion 430 can be understood to occur at a portion of the substrate 190 with a thickness that is approximately equal to the thickness of the substrate 190 at either the first endpoint or second endpoint. The terms “raised portion” and “recessed portion” can therefore be understood to be used relative to these ‘zero-level’ substrate thickness levels.

As shown in FIG. 5, the apex 390, as the highest point, extends upward relative to the dotted line by a first height 510, and the nadir 449, as the lowest point, dips down to a first depth 520 relative to the dotted line. It can be appreciated in FIG. 5 that the raised portion is a substantially symmetrical region about the center of the receptacle 120, while the recessed portion extends, surrounds, or encircles the raised portion, and can be seen to therefore include ‘two’ regions 124a and 124b in the cutaway view.

In FIGS. 6A and 6B, a direct side view of the cutaway portion 600 is depicted, better illustrating the structural relationship between the housing 110 and the receptacle 120. In particular, the curvature of a lower surface 610 of the second unit 114 in conjunction with the curvature of an upper surface 620 of substrate 190 can be seen. In FIG. 6A, it can be observed that the interior volume of space bounded or extending between the housing 110 and the receptacle 120 (and further bounded by pillars 128 along the outermost periphery) increases continuously in a radially outward direction 650 from the base portion 430 to the peripheral border 126. In some implementations, the volume may be understood to increase monotonically. This is further reflected by the continuously increasing distance between the lower surface 610 and the upper surface 620. Specifically, a first distance “A” extending in a vertical direction between the portion of the lower surface 610 closest to the outermost ring 330 and the portion of the upper surface 620 closest to the base portion 430 is smaller than a second distance “B” that is radially further from the center of the system 100. Similarly, second distance “B” is smaller than a third distance “C” which is further from the center than second distance “B”, and a fourth distance “D” that is further from the center is larger than third distance “C”. A fifth distance “E” further outward from the center is again larger than the fourth distance “D”, and a sixth distance “F” is largest, corresponding to the furthest boundary of the interior volume.

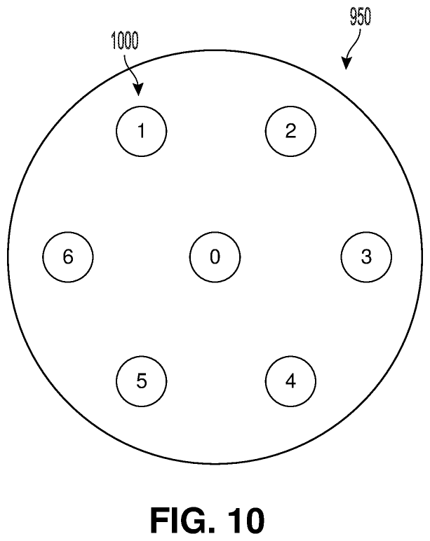

The profound technical effect and benefits of this arrangement can be understood with reference to FIG. 6B, where the ‘flow’ of the audio stream being emitted from the speaker 200 is schematically illustrated. The alignment of the base portion 430 of the substrate 190 below with the outermost ring 330 of the diaphragm 460 above, along the vertical direction 150, as indicated by a pair of dotted lines extending between the speaker 200 and the raised portion 122 serves as an initial sound flow region. Because the outer edge of the speaker 200 is circular, and has a diameter that is substantially similar to the circular diameter of the raised portion (which is bounded by the base portion 430), the dotted lines can be understood to refer to a substantially cylindrical three-dimensional volume surrounding the apex 390. The audio emitted by speaker 200 can be understood to be spread, diverted, or redirected in an approximately even flow of sound along a radially outward stream, starting from the centrally located apex 390 and conveyed along a continuously downward sloping surface, until reaching the nadir 440. The audio flow, spread across 360 degrees, is then guided along a continuously upward sloping surface until exiting from the spaces formed between the plurality of pillars 128. This dynamic flow of sound both improves the quality of audio while reducing the effects of the audio on the microphone array (see FIG. 10).

In some implementations, as is achieved with the implementation shown in FIGS. 1-6B, the particular size, dimensions, and physical characteristics of the housing receptacle, in conjunction with the geometry of the housing, are designed such that a wideband audio [200,8000] Hz frequency response of ±4 dB is achieved with total harmonic distortion (THD) of less than 3% for [200,8000] Hz at an output volume set to 89 dBA SPL at 1 kHz at 0.5 m. In some examples, these characteristics are also designed such that with an output volume set to 80 dBA SPL at 1 kHz at 0.5 m, the THD is less than 2% for [200,8000] Hz. Realization of such output characteristics improves the quality of audio rendering to users, as well as reduces nonlinearities in speaker output received by microphones that can negatively affect echo cancellation or other processing of microphone audio signals. In some examples, this may be achieved with the lower surface 610 and the upper surface 620 being approximately arranged with distances A, B, C, D, E, and F of approximately 4.6 mm, 5.4 mm, 6.6 mm, 8.5 mm, 11 mm, and 16.5 mm respectively and an approximate distance of 2.3 mm between the nadir 390 and a center of the inner surface 500 of the diaphragm 460. In some examples, the distance F is at least 14 mm, as a smaller distance will significantly interfere with realizing the above output characteristics. In some examples, the archways around the periphery of the housing receptacle have a height of at least 14 mm, as a shorter height will significantly interfere with realizing the above output characteristics.

In an example achieving the above output response, the speaker 200 is a SP330204-2 dynamic speaker by DB Unlimited, LLC of Dayton, Ohio, US with specifications including 99 dBA SPL at 10 cm, resonant frequency of 280 Hz, frequency range of 280-20,000 Hz, nominal power of 3 W, maximum power of 3.5 W, impedance of 4Ω, a maximum vibration of 2 mm, and a paper cone with a polyurethane edge. In some implementations, an audio signal may be processed to produce an output audio signal provided to the speaker 200 to flatten the frequency response. This processing may apply techniques such as, but not limited to, equalization (for example, an equalization notch filter).

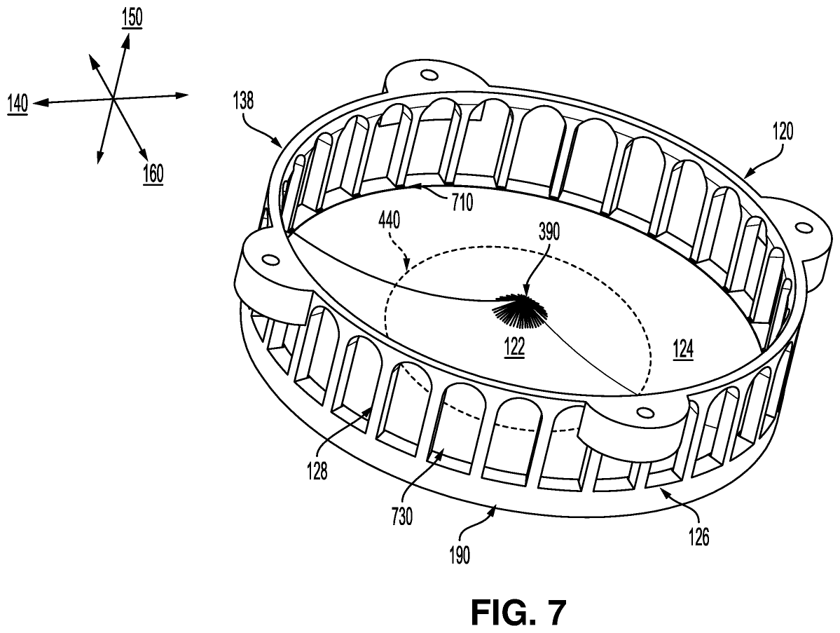

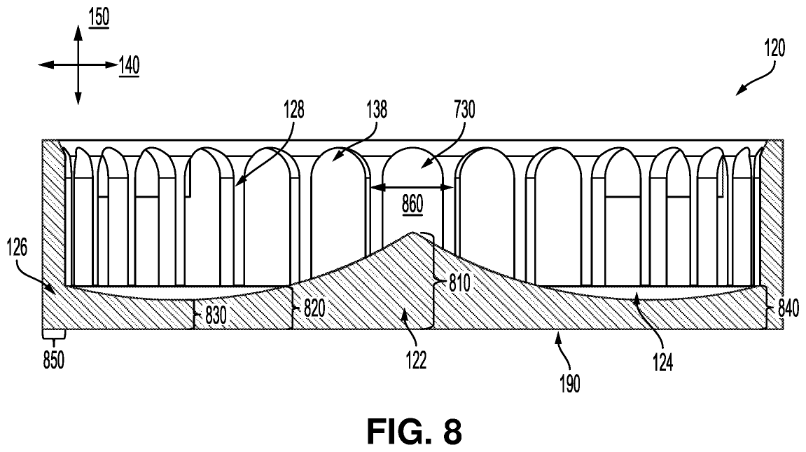

The two isolated views of the receptacle 120 shown in FIGS. 7 and 8 more clearly illustrate the structural features and benefits provided by the receptacle 120. In FIG. 7, an isometric view of the receptacle 120 is depicted, in which the circular shape of the receiving ring 138, the peripheral border 126, and the substrate 190 can be clearly observed. In addition, the raised portion 122 can be seen to include a round outer border, indicated by a dotted line, while the recessed portion 124 has a flat torus (e.g., a donut-shape) that surrounds or encircles the raised portion 122, extending from the base portion to an inner circumference 710 of the peripheral border 126. The archway openings 730 formed by each neighboring pair of pillars 128 are also apparent in FIG. 7. In different implementations, the pillars 128 can be understood to be staggered or spaced apart at equal intervals from one another. Thus, the distance between each pillar is approximately the same around the peripheral border 126, ensuring the equal distribution of sound from around the device.

In FIG. 8, a cross-sectional cutaway portion of the receptacle 120 is provided to better illustrate the structural characteristics associated with the internal curvature and geometry of substrate 190. In this view, the continuously curving surface of the substrate 190 can be seen. For example, the raised portion 122 has a maximum, first thickness 810 that extends up to the apex, also corresponding to the thickest region of the substrate 190, as well as a smaller, second thickness 820 associated with the base portion. The recessed portion 124 has a third thickness 830 that is the narrowest region of the substrate 190, and the edge of the substrate 190 along the peripheral border 126 has a fourth thickness 840 that is substantially similar to the second thickness 820 (at the base portion). Thus, the downwardly sloped surface can be seen to intersect or merge with the upwardly sloped surface along the recessed portion at the nadir. In some implementations, the curvature of recessed portion 124 is substantially symmetrical in the horizontal direction about the nadir. In addition, a first distance 860 between a first set of pillars and a second distance 862 between a second set of pillars can be understood as being substantially equal.

Returning to a broader understanding of the system, in different implementations, the device can include a plurality of input or output components, such as a circular microphone array (see FIGS. 9 and 10 below), a downwardly-facing or down-firing speaker, a USB connection, as well as LEDs and/or buttons or other interactive mechanisms. The microphone array is preferably disposed toward a top portion of the system without occlusion from the top surface. Furthermore, the proposed arrangement ensures that a vertical height of the system, from the bottom surface of the substrate 190 to the top of the housing 110, will not exceed 50 mm. This size can help decrease the detrimental effects of sound reflections from the table or other surface on which the system resides that can reduce the intelligibility of the signal generated by the microphones. In addition, in different implementations, the device can include a CPU, configured with its own OS environment.

As a general matter, in different implementations, the audio format should minimally be 16 kHz, 16-bits per sample, and/or mono, although higher sampling rates such as 44.1 kHz or 48 kHz may also be used. The microphone array can be opened in a shared mode to access multiple pulse-code modulation (PCM) streams, or in an exclusive mode to access a Free Lossless Audio Codec (FLAC) encoded bitstream. In some implementations, the audio device can be configured to support a sampling rate of 96 kHz and 24-bits per sample, mono (8-ch PCM encoded to FLAC). This sampling rate and bit depth ensures a throughput of at least 2 Mbps.

Furthermore, the seven microphone channels and one loudspeaker channel may be presented to the FLAC encoder as an 8-channel PCM input sampled at 16 kHz and using 16 bits per sample, where channels 0 to 6 correspond to the microphones 0 to 6 in the circular array and channel 7 corresponds to the loudspeaker signal. The microphones can be numbered, for example, in a clockwise or counter-clockwise fashion. The resulting output can be presented to an audio session API as a mono stream. Furthermore, the audio device can be configured to provide a constant bit rate (CBR) signal.

Because the uncompressed bitrate for 16 kHz sampled audio at 16 bits per sample is 256 kbps and FLAC typically achieves a bit rate reduction of 40-50% depending on the signal content, the audio system can also be configured to account for 256 kbps per channel (uncompressed rate). In different implementations, the audio system conforms to wideband and narrowband speakerphone IEEE standards (such as, but not limited to, IEEE 1329), ITU standards (such as, but not limited to, ITU-T P.340), and/or TIA standards (such as, but not limited to, TIA-920.120).

As noted earlier, the audio system is configured to generate audio streams and metadata signals and send the output to a cloud service or other communication management application, for example wirelessly or through a USB or other electro-mechanical connection. More specifically, in some implementations, the audio streams can include a loudspeaker reference signal, as well as various types of mic signals, each optimized for a particular operation, such as VOIP calls, Internet telecommunications, virtual assistant interactions, diarized transcription, and other operations.

In different implementations, the loudspeaker that will be incorporated in the audio system can be associated with specifications such as, but not limited to (a) a frequency response of [100, 8000] Hz with a response per the TIA-920 Handsfree Receive Response Mask; (b) Power of 89 dBA SPL peak at 1 kHz at 0.5 m with a max input of 3 Watts; (c) a 76 mm maximum diameter; (d) an enclosure with an airtight acoustic sealing. Furthermore, the loudspeaker amplifier can include specifications such as (a) one channel support; (b) a power output of 3 Watts maximum; (c) a DAC that supports a gain, which can be used for volume control, where the volume supports at least 64 logarithmic level differences.

The loudspeaker grille that is incorporated into the system is further configured to cover the vertical sides of loudspeaker and protect the loudspeaker from physical damage. The grille is acoustically transparent, such that directivity will not change by more than 1 dB amplitude or 10° phase in any direction (although in some examples, the acoustic transparency ensures that directivity will not change by more 1° phase in any direction). Referring to FIG. 9, an example of an audio system 950 including the proposed device and receptacle is depicted and enclosed in an outermost covering (“covering”) 900 including a grille is shown. In this example, the system has a substantially squat, cylindrical shape, similar to a ‘puck’. In different implementations, the covering 900 can be aesthetically pleasing, offered in a wide range of colors, and present an outer surface that is easy to clean. The grille can include openings arranged in a substantially homogeneous pattern, with a diameter that is at least as large as the diameter of the loudspeaker. In some examples, the grille open area is at least 40%. In some examples, the grille open area is at least 57%. In addition, the assembled device with external covering 900 will be suitably small and configured for a low profile and minimal obtrusiveness in a room or other space. In one example, the device has a maximum diameter of 34 mm, and a sealed back cavity of approximately 120 cc.

Some implementations of the audio system may also include buttons that allow the user to interact with the device. The buttons can be configured to produce minimal to no sound, with less than a 10 dBA clicking noise as measured by the microphones. In other implementations, the interactions can occur by a remote mechanism, such as a remote control, or a separate application running on another computing device configured to communicate with the audio system. For example, the device can include a “volume up” and “volume down” button, or these interactions can occur via a remote console. Other interactions such as activation or deactivation of transcription and recording can also be offered remotely, or be voice-activated. In some implementations, and shown in FIG. 9, the device can include a mute button 910 which, when activated, can trigger the display of a change in appearance (e.g., a red LED) that is clearly visible from a distance (e.g., is visible to users seated four meters distant from the device), and/or the corresponding remote audio service can display a mute message. Similarly, when the device is unmuted, the appearance can revert to its original appearance (e.g., the red LED light is turned off). In one implementation, the device will not have any other buttons in order to promote control of the system by remote consoles.

In addition, in some implementations, the device can include an arrangement of LEDs. For example, a set of LED light pipes can be incorporated in the device which can be configured to indicate various states of the device as well as indicate the mute status. The light display 920 can be arranged to surround the device on the surface or periphery, for example in a circle. The lights can be combined to show a combination of states for a virtual assistant state and meeting communications. For example, the device cover can be configured to light up in a sequence of two or more colors before or during a meeting, or one color (e.g., blue) to indicate a non-muted active status, switch to another color (e.g., red) when the device is muted, while no light is shown when the device is in an idle state. Furthermore, in some implementations, the light pattern can change dynamically in response to the state of the virtual assistant or other communication-based service. For example, if the virtual assistant is in a ‘listening’ mode, following the utterance of a ‘wake word’ or other user command, the system may light up or remain dormant until the conclusion of the user request, when the light can display a pulsing or blinking pattern to indicate that the virtual assistant is processing or ‘thinking’ about the user's input. Similarly, the device can transition to a solid light display during the rendering of a response.

In some implementations, the base of the device can include a micro security slot, similar to slots built into portable computing devices such as laptops to lock the system, for example with a cable, to deter theft. In different implementations, a Type A USB 2.0 cable can be used connect the audio device to a remote service, as well as serve as a power cable. However, if there is a need to increase power to the device to provide a higher amplitude for the speaker, an alternate cable that carries both power and USB data can be used to connect the device to a Power and Data Box (PDB) that can, for example, be placed under the table or other support surface, out of sight. The PDB can be a small box that combines USB and power cable into one thin cable and include a power connector, a USEB connector, and a PDB connector. Such connectors will be configured to provide enough stress relief to ensure the connector will not be inadvertently pulled from the PCB. For example, a direct pull force requirement of 45N can be supported for some or all connections to the device and PDB.

In addition, the device can be configured to minimize audio latency (i.e., the time it takes for a sound at the microphone to the time that sound is transmitted as a network packet (VoIP)), for example to a maximum of 80 ms, and to provide synchronization of audio and video signals to avoid lip-sync errors.

Referring now to FIG. 10, a top-down view of an implementation of the audio system 950 including a microphone array 1000 is provided. As shown in FIG. 10, in some implementations, the device includes a “6+1” microphone array on a top surface, whereby six microphones are arranged in a circle (identified as “1”, “2”, “3”, “4”, “5”, and “6” in FIG. 10) and a seventh microphone (identified as “0” in FIG. 10) is located toward or at the center. The array is configured to capture audio for telecommunication sessions and events, speech, recording and transcription services, and virtual assistant interactions. Thus, a single microphone array can be utilized for both speech and meeting audio. There are a plurality of channels for audio data, and one channel for the reference audio data. As the microphone layout is fixed, the system is better able to distinguish between different sources of speech (i.e., people) who might be positioned or seated around the device.

In some implementations, the microphones are distributed evenly to form a substantially hexagonal arrangement, with an additional microphone in the center. The mics are placed horizontally and evenly in a circle with microphone ports face upward. In one implementation, the array radius is approximately 4.25 cm, and the microphone distances can be adjusted by about 5%. The array can include digital MEMS microphone(s), and be configured for omnidirectionality. In some implementations, the array has a sampling rate of 16 kHz, and a 24 bit sampling accuracy, with a listening Range for speech of up to 4 m. However, in other implementations, the specifications indicated for the microphones may differ.

U.S. Pat. No. 7,415,117 (issued on Aug. 19, 2008 and entitled “SYSTEM AND METHOD FOR BEAMFORMING USING A MICROPHONE ARRAY”) and U.S. Patent Application Publication Number 2019/0236416 (published on Aug. 1, 2019 and entitled “ARTIFICIAL INTELLIGENCE SYSTEM UTILIZING MICROPHONE ARRAY AND FISHEYE CAMERA”) are each incorporated by reference herein in their entireties.

While various embodiments have been described, the description is intended to be exemplary, rather than limiting, and it is understood that many more embodiments and implementations are possible that are within the scope of the embodiments. Although many possible combinations of features are shown in the accompanying figures and discussed in this detailed description, many other combinations of the disclosed features are possible. Any feature of any embodiment may be used in combination with or substituted for any other feature or element in any other embodiment unless specifically restricted. Therefore, it will be understood that any of the features shown and/or discussed in the present disclosure may be implemented together in any suitable combination. Accordingly, the embodiments are not to be restricted except in light of the attached claims and their equivalents. Also, various modifications and changes may be made within the scope of the attached claims.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claims require more features than are expressly recited in each claim. Rather, as the following claims reflect, inventive subject matter lies in less than all features of a single disclosed example. Thus, the following claims are hereby incorporated into the Detailed Description, with each claim standing on its own as a separately claimed subject matter.

1-10. (canceled)

11. An audio system comprising:
a receptacle including a substrate base layer;
a housing assembly including an upper housing unit and a lower housing unit, the upper housing unit being positioned above the lower housing unit and being further away from the substrate base layer of the receptacle than the lower housing unit;
a microphone array disposed on a surface of the upper housing unit; and
a down-firing speaker disposed within the housing assembly and facing toward the sub state base layer of the receptacle,
wherein the receptacle raises the housing assembly above the substrate base layer.

12. The audio system of claim 11, wherein the receptacle further includes:
a raised portion extending from a base portion distally upward to an apex in a central region of the substrate base layer,
a recessed portion of the substrate base layer encircling the raised portion, the recessed portion including a continuously curved, concave surface extending in a radially outward direction from the base portion to a peripheral border portion that surrounds the recessed portion, and
a plurality of pillars extending distally upward from the peripheral border portion, each of the plurality of pillars supporting a receiving ring disposed above the substrate base layer.

13. The audio system of claim 12, wherein the down-firing speaker is disposed within the housing assembly that includes a first connecting portion protruding radially outward from the housing assembly, the first connecting portion being configured to connect to a second connecting portion of the receiving ring to secure the down-firing speaker within the receptacle.

14. The audio system of claim 12, wherein the down-firing speaker includes a central vertical axis that is above and aligned with the apex in the central region of the substrate base layer of the receptacle.

15. The audio system of claim 11, wherein the receptacle is configured to receive the microphone array and the down-firing speaker.

16. The audio system of claim 12, wherein the apex extends upward into a cavity formed by a diaphragm of the down-firing speaker.

17. An audio system comprising:
a receptacle including a substrate base layer;
and
an audio device disposed within the receptacle and located above the substrate base layer, the audio device including:
a housing assembly including a lower housing unit joined to an upper housing unit, the lower housing unit including an aperture and a downwardly-facing exterior surface that surrounds the aperture,
a down-firing speaker disposed within the housing assembly adjacent to an interior surface of the lower housing unit, and
a microphone array disposed on the upper housing unit of the housing assembly, the microphone array including microphones with upward microphone ports.

18. The audio system of claim 17, wherein the receptacle includes:
a raised portion extending radially inward from a base portion to an apex,
a recessed portion encircling the raised portion,
a peripheral border portion surrounding the recessed portion, and
wherein the apex is disposed directly beneath a central region of a diaphragm.

19. The audio system of claim 17, wherein the down-firing speaker includes a diaphragm with an outermost ring configured to align with the aperture of the lower housing unit.

20. The audio system of claim 17, wherein:
a vertical height from the substrate base layer to a top surface of the upper housing unit does not exceed 50 mm, and
the audio system is configured to output audio with, for a frequency range from 280 to 8,000 Hz and with an output volume set to produce 89 dBA SPL at 1 kHz at 0.5 meters, a frequency response of ±4 dB and a total harmonic distortion (THD) of less than 3%.

21. An audio device comprising:
a housing assembly including a lower housing unit above a base surface, and an upper housing unit formed above the lower housing unit;
a microphone array positioned on a surface of the upper housing unit of the housing assembly, the microphone array including microphones having microphone ports; and
a down-firing speaker disposed within the housing assembly below the surface on which the microphone array is positioned, and adjacent to an interior surface of the lower housing unit of the housing assembly, the speaker being elevated from the base surface and down-firing to the base surface, wherein the microphone array includes a microphone having a microphone port facing a direction different from a direction of the down-firing of the speaker.

22. The audio device of claim 21, wherein the down-firing speaker includes a diaphragm with an outermost ring configured to align with an aperture of the lower housing unit.

23. The audio device of claim 21, wherein the housing assembly is coupled to a receptacle for positioning the microphone array and the down-firing speaker.

24. The audio device of claim 23, wherein the down-firing speaker includes a central vertical axis, the central vertical axis being above and aligned with an apex in a central region of a substrate base layer of the receptacle.

25. The audio device of claim 21, wherein sound is emitted from an audio-emitting source of the down-firing speaker through an acoustically transparent grille enclosing the speaker.

26. The audio device of claim 25, wherein the grille includes openings arranged in a homogeneous pattern with a diameter that is equal to or greater than a diameter of the down-firing speaker.

27. The audio device of claim 25, wherein a change of directivity through the acoustically transparent grille is less than 1 dB amplitude in a direction.

28. The audio device of claim 21, wherein the microphone array has an array radius about 4.25 cm, and a distance between microphones is adjustable by about 5%.

29. The audio device of claim 21, wherein the microphones are placed horizontally and evenly in a circle with the microphone ports facing in an upward direction different from the direction of the down-firing of the speaker.

30. The audio device of claim 21, further comprising a set of LED light pipes that indicate various states of the audio device, the various states including a mute status.
